(19) United States
(12) Patent Application Publication
(10) Pub. No.: US 2021/0072820 A1
(43) Pub. Date: Mar. 11, 2021

(54) STICKY DEVICE TO TRACK ARM MOVEMENTS IN GENERATING INPUTS FOR COMPUTER SYSTEMS

(71) Applicant: Finch Technologies Ltd., Fish Bay (VG)

(72) Inventors: Viktor Vladimirovich Erivantcev, Ufa (RU); Alexey Ivanovich Kartashov, Moscow (RU); Iakov Evgenevich Sergeev, Ufa (RU); Ravil Salavatovich Shafikov, Kumertau (RU); Gary Stuart Yamamoto, Sacramento, CA (US)

(21) Appl. No.: 17/009,159

(22) Filed: Sep. 1, 2020

Related U.S. Application Data
(60) Provisional application No. 62/897,126, filed on Sep. 6, 2019.

(51) Int. Cl. G06F 3/01; G06F 3/0346

(52) U.S. Cl. CPC G06F 3/011; G06F 3/0346

(57) ABSTRACT

A system includes a computing device having one or more processors and a plurality of sensor modules in electronic communication with the computing device via a communication module of at least one of the plurality of sensor modules. The plurality of sensor modules each include a housing and an inertial measurement unit disposed in the housing. A first of the plurality of sensor modules includes a sticky pad attached to the housing. The sticky pad has a sticky surface configured to be sticking to a user to attach the first of the plurality of sensor modules to the user.

### RELATED APPLICATIONS

The present application claims the benefit of priority to U.S. Provisional App. Ser. No. 62/897,126, filed on Sep. 6, 2019, the entire disclosure of which application is hereby incorporated herein by reference.

The present application relates to U.S. patent application Ser. No. 15/787,555, filed Oct. 18, 2017, issued as U.S. Pat. No. 10,379,613 on Aug. 13, 2019, and entitled “Tracking Arm Movements to Generate Inputs for Computer Systems,” the entire disclosure of which application is hereby incorporated herein by reference.

The present application further relates to U.S. patent application Ser. No. 15/492,915, filed Apr. 20, 2017, published as U.S. Pat. App. Pub. No. 2017/0308165 on Oct. 26, 2017, and entitled “Devices for Controlling Computers based on Motions and Positions of Hands,” U.S. patent application Ser. No. 15/817,646, filed Nov. 20, 2017, published as U.S. Pat. App. Pub. No. 2018/0313867 on Nov. 1, 2018, and entitled “Calibration of Inertial Measurement Units Attached to Arms of a User to Generate Inputs for Computer Systems,” U.S. patent application Ser. No. 15/813,813, filed Nov. 15, 2017, published as U.S. Pat. App. Pub. No. 2018/0335834 on Nov. 22, 2018, and entitled “Tracking Torso Orientation to Generate Inputs for Computer Systems,” U.S. patent application Ser. No. 15/847,669, filed Dec. 19, 2017, published as U.S. Pat. App. Pub. No. 2019/0187784 on Jun. 20, 2019, and entitled “Calibration of Inertial Measurement Units Attached to Arms of a User and to a Head Mounted Device,” U.S. patent application Ser. No. 15/868,745, filed Jan. 11, 2018, published as U.S. Pat. App. Pub. No. 2019/0212359 on Jul. 11, 2019, and entitled “Correction of Accumulated Errors in Inertial Measurement Units Attached to a User,” U.S. patent application Ser. No. 15/864,860, filed Jan. 8, 2018, published as U.S. Pat. App. Pub. No. 2019/0212807 on Jul. 11, 2019, and entitled “Tracking Torso Leaning to Generate Inputs for Computer Systems,” U.S. patent application Ser. No. 15/973,137, filed May 7, 2018, and entitled “Tracking User Movements to Control a Skeleton Model in a Computer System,” U.S. patent application Ser. No. 15/996,389, filed Jun. 1, 2018, issued as U.S. Pat. No. 10,416,755 on Sep. 17, 2019, and entitled “Motion Predictions of Overlapping Kinematic Chains of a Skeleton Model used to Control a Computer System,” U.S. patent application Ser. No. 16/044,984, filed Jul. 25, 2018, and entitled “Calibration of Measurement Units in Alignment with a Skeleton Model to Control a Computer System,” U.S. patent application Ser. No. 16/375,108, filed Apr. 4, 2019, and entitled “Kinematic Chain Motion Predictions using Results from Multiple Approaches Combined via an Artificial Neural Network,” U.S. patent application Ser. No. 16/534,674, filed Aug. 7, 2019, and entitled “Calibration of Multiple Sensor Modules Related to an Orientation of a User of the Sensor Modules,” the entire disclosures of which applications are hereby incorporated herein by reference.

### FIELD OF THE TECHNOLOGY

The embodiments disclosed herein relate to computer input devices in general and more particularly but not limited to input devices for virtual reality and/or augmented/mixed reality applications implemented using computing devices, such as mobile phones, smart watches, similar mobile devices, and/or other devices.

### BACKGROUND

U.S. Pat. App. Pub. No. 2014/0028547 discloses a user control device having a combined inertial sensor to detect the movements of the device for pointing and selecting within a real or virtual three-dimensional space.

U.S. Pat. App. Pub. No. 2015/0277559 discloses a finger-ring-mounted touchscreen having a wireless transceiver that wirelessly transmits commands generated from events on the touchscreen.

U.S. Pat. App. Pub. No. 2015/0358543 discloses a motion capture device that has a plurality of inertial measurement units to measure the motion parameters of fingers and a palm of a user.

U.S. Pat. App. Pub. No. 2007/0050597 discloses a game controller having an acceleration sensor and a gyro sensor. U.S. Pat. No. D772,986 discloses the ornamental design for a wireless game controller.

Chinese Pat. App. Pub. No. 103226398 discloses data gloves that use micro-inertial sensor network technologies, where each micro-inertial sensor is an attitude and heading reference system, having a tri-axial micro-electromechanical system (MEMS) micro-gyroscope, a tri-axial micro-acceleration sensor and a tri-axial geomagnetic sensor which are packaged in a circuit board. U.S. Pat. App. Pub. No. 2014/0313022 and U.S. Pat. App. Pub. No. 2012/0025945 disclose other data gloves.

The disclosures of the above discussed patent documents are hereby incorporated herein by reference.

### SUMMARY

A system is disclosed. The system includes a computing device having one or more processors and a plurality of sensor modules in electronic communication with the computing device via a communication module of at least one of the plurality of sensor modules. The plurality of sensor modules each include a housing and an inertial measurement unit disposed in the housing. A first of the plurality of sensor modules includes a sticky pad attached to the housing. The sticky pad has a sticky surface configured to be sticking to a user to attach the first of the plurality of sensor modules to the user.

A method is also disclosed. The method includes receiving, by a computing device, motion data from an arm module identifying an orientation of an upper arm of a user. The method further includes receiving, by the computing device, motion data from a handheld module identifying an orientation of a hand of the user. The method includes calculating, by the computing device, an orientation of a forearm of the user connecting the hand and the upper arm, wherein the orientation is calculated without a sensor module being present on the forearm.

### BRIEF DESCRIPTION OF THE DRAWINGS

The embodiments are illustrated by way of example and not limitation in the figures of the accompanying drawings in which like references indicate similar elements.

FIG. 1 illustrates a system to track arm movements according to one embodiment.

FIG. 2 illustrates a system to control computer operations according to one embodiment.

FIG. 3 illustrates a skeleton model of an arm.

FIG. 4 illustrates the determination of the orientation of a forearm according to one embodiment.

FIG. 5 shows a method to compute the orientation of a forearm according to one embodiment.

FIG. 6 shows a detailed method to compute the orientation of a forearm according to one embodiment.

FIG. 7 shows a sensor module sticking to an upper arm according to one embodiment.

FIG. 8 shows a sensor module having a sticky pad for attaching to a user according to one embodiment.

### DETAILED DESCRIPTION

The following description and drawings are illustrative and are not to be construed as limiting. Numerous specific details are described to provide a thorough understanding. However, in certain instances, well known or conventional details are not described to avoid obscuring the description. References to one or an embodiment in the present disclosure are not necessarily references to the same embodiment; and, such references mean at least one.

At least some embodiments disclosed herein allow arm movement tracking without a sensor device attached to the forearm. The forearm orientation is estimated, predicted, or computed from the orientation of the upper arm connected to the forearm and the orientation of the hand connected to the forearm.

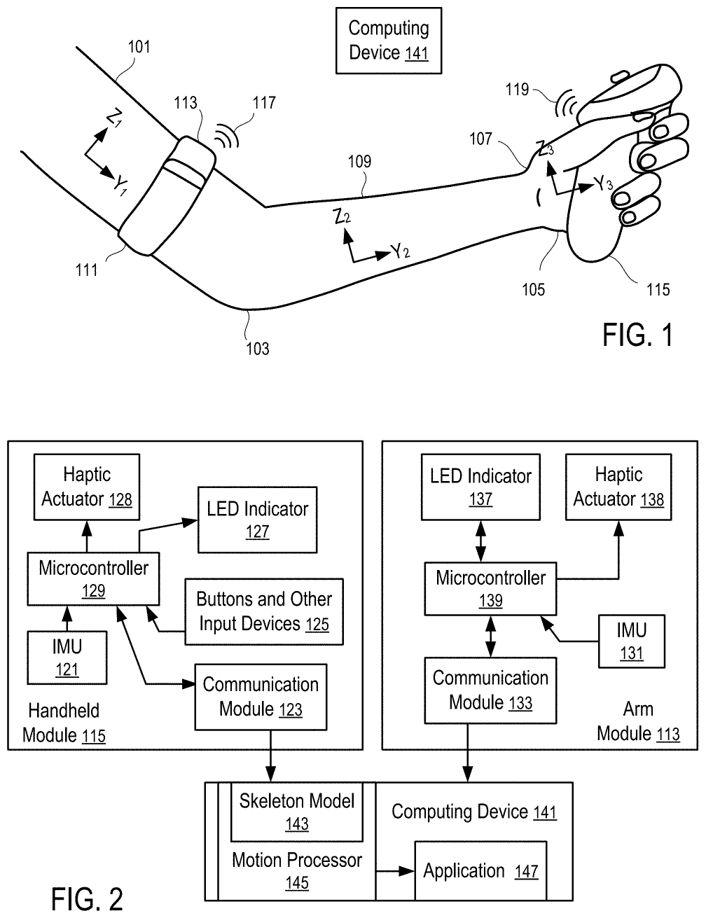

FIG. 1 illustrates a system to track arm movements according to one embodiment.

In FIG. 1, an elbow joint (103) of a user connects an upper arm (101) and a forearm (109) of the user; and a wrist (107) connects the forearm (109) to a hand (105) of the user.

The orientation of the upper arm (101) is tracked/determined using an arm module (113) that is attached to the upper arm (101) via an armband (111). The orientation of the upper arm (101) is represented by a local coordinate system X₁Y₁Z₁, where the lengthwise direction Y₁ is in parallel with the direction from the shoulder to the elbow joint (103), the direction X₁ is in parallel with the direction from the inner side of the upper arm (101) to the outer side of the upper arm (101), and the direction Z₁ is in parallel with the direction from the back side of the upper arm (101) to the front side of the upper arm (101).

The orientation of the hand (105) is tracked/determined using a handheld module (115). The orientation of the hand (105) is represented by a local coordinate system X₃Y₃Z₃, where the lengthwise direction Y₃ is in parallel with the direction from the wrist (105) to the fingers, the direction X₃ is in parallel with the direction from the back of the hand (105) to the palm of the hand (105), and the direction Z₃ is in parallel with the direction from the edge of the palm to the thumb on the hand (105).

Preferably, the arm module (113) and the handheld module (115) separately report their motion/orientation parameters to a computing device (141) using wireless connections (117 and 119), such as a personal area wireless network connection (e.g., Bluetooth connections), or a local area wireless network connection (e.g., Wi-Fi connections).

Alternatively, the arm module (113) may report its measurements to the handheld module (115) (via a wired or wireless connection); and the handheld module (115) communicates the motion/orientation measurements to the computing device (141) (e.g., via a wired or wireless connection).

For example, the handheld module (115) and the arm module (113) can be respectively a base unit (or a game controller) and an arm/shoulder module discussed in U.S. patent application Ser. No. 15/492,915, filed Apr. 20, 2017 and entitled “Devices for Controlling Computers based on Motions and Positions of Hands”, the entire disclosure of which application is hereby incorporated herein by reference.

At least some embodiments disclosed herein allow the orientation of the forearm (109) to be estimated, predicted, or calculated from the orientation of the hand (105) and the orientation of the upper arm (101) without the need for an additional sensor module to track the orientation of the forearm (109), as further discussed below.

FIG. 2 illustrates a system to control computer operations according to one embodiment. For example, the system of FIG. 2 can be implemented via attaching the handheld module (115) and the arm module (113) to the hand (105) and the upper arm (101) respectively in a way illustrated in FIG. 1.

In FIG. 2, the handheld module (115) and the arm module (113) have micro-electromechanical system (MEMS) inertial measurement units (IMUs) (121 and 131) that measure motion parameters and determine orientations of the hand (105) and the upper arm (101).

Each of the IMUs (131, 121) has a collection of sensor components that enable the determination of the movement, position and/or orientation of the respective IMU along a number of axes. Examples of the components are: a MEMS accelerometer that measures the projection of acceleration (the difference between the true acceleration of an object and the gravitational acceleration); a MEMS gyroscope that measures angular velocities; and a magnetometer that measures the magnitude and direction of a magnetic field at a certain point in space. In some embodiments, the IMUs use a combination of sensors in three and two axes (e.g., without a magnetometer).

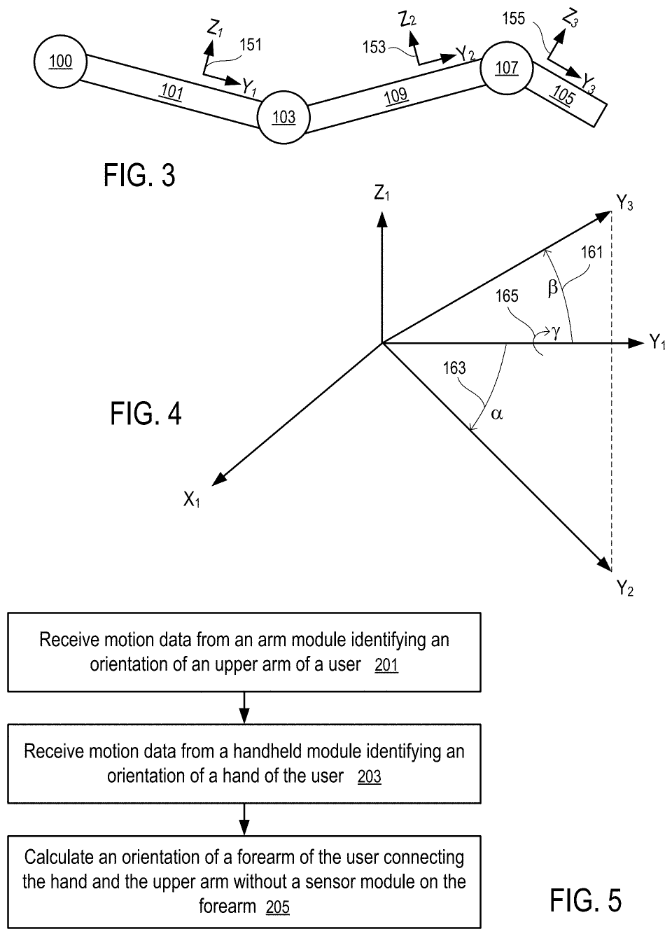

The computing device (141) has a motion processor (145), which includes a skeleton model (143) of the upper arm (101), the forearm (109), and the hand (105) connected via the elbow joint (103) and the wrist (107) (e.g., illustrated FIG. 3). The motion processor (145) controls the movements of the corresponding parts of the skeleton model (143) according to the movements/orientations of the upper arm (101) and the hand (105) measured by the arm module (113) and the handheld module (115).

Since the forearm (109) does not have an attached sensor module, the movements/orientations of the forearm (109) is calculated/estimated/predicted from the orientation of the arm module (113) and the orientation of the handheld module (115), as discussed further below.

The skeleton model (143) as controlled by the motion processor (145) generates inputs for an application (147) running in the computing device (141). For example, the skeleton model (143) can be used to control the movement of an avatar/model of the arm of the user of the computing device (141) in a video game, a virtual reality, a mixed reality, or augmented reality, etc.

In some applications, the handheld module (115) can be replaced with an arm module (113) attached to the hand (105) via holding or via a strap.

Preferably, the arm module (113) has a microcontroller (139) to process the sensor signals from the IMU (131) of the arm module (113) and a communication module (133) to transmit the motion/orientation parameters of the arm module (113) to the computing device (141). Similarly, the handheld module (115) has a microcontroller (129) to process the sensor signals from the IMU (121) of the handheld module (115) and a communication module (123) to transmit the motion/orientation parameters of the handheld module (115) to the computing device (141).

Optionally, the arm module (113) and the handheld module (115) have LED indicators (137 and 127) respectively to indicate the operating status of the modules (113 and 115).

Optionally, the arm module (113) and the handheld module (115) have haptic actuators (138 and 128) respectively to provide haptic feedback to the user via the modules (113 and 115).

Optionally, the handheld module (115) has buttons and other input devices (125), such as a touch sensor, a joystick, etc.

Typically, an IMU (e.g., 131 or 121) in a module (e.g., 113 or 115) generates acceleration data from accelerometers, angular velocity data from gyrometers/gyroscopes, and/or orientation data from magnetometers. The microcontrollers (139 and 129) perform preprocessing tasks, such as filtering the sensor data (e.g., blocking sensors that are not used in a specific application), applying calibration data (e.g., to correct the average accumulated error computed by the computing device (141)), transforming motion/position/orientation data in three axes into a quaternion, and packaging the preprocessed results into data packets (e.g., using a data compression technique) for transmitting to the host computing device (141) with a reduced bandwidth requirement and/or communication time.

Each of the microcontrollers (129, 139) may include a memory storing instructions controlling the operation of the respective microcontroller (129 or 139) to perform primary processing of the sensor data from the IMU (121, 131) and control the operations of the communication module (123, 133), and/or other components, such as the LED indicator (127, 137), the haptic actuator (128, 138), buttons and other input devices (125).

The computing device (141) may include one or more microprocessors and a memory storing instructions to implement the motion processor (145). The motion processor (145) may also be implemented via hardware, such as Application-Specific Integrated Circuit (ASIC) or Field-Programmable Gate Array (FPGA).

In some instances, one of the modules (113 and 115) is configured as a primary input device; and the other module is configured as a secondary input device that is connected to the computing device (141) via the primary input device. A secondary input device may use the microprocessor of its connected primary input device to perform some of the preprocessing tasks. A module that communicates directly to the computing device (141) is considered a primary input device, even when the module does not have a secondary input device that is connected to the computing device via the primary input device.

In some instances, the computing device (141) specifies the types of input data requested, and the conditions and/or frequency of the input data; and the modules (113 and 115) report the requested input data under the conditions and/or according to the frequency specified by the computing device (141). Different reporting frequencies can be specified for different types of input data (e.g., accelerometer measurements, gyroscope/gyrometer measurements, magnetometer measurements, position, orientation, velocity).

In general, the computing device (141) may be a data processing system, such as a mobile phone, a desktop computer, a laptop computer, a head mount virtual reality display, a personal medial player, a tablet computer, etc.

FIG. 3 illustrates a skeleton model of an arm. For example, the skeleton model of FIG. 3 can be used in the motion processor (145) of FIG. 2 to determine the orientation of the forearm (109) that does not have an attached sensor module, as illustrated in FIG. 1.

FIG. 3 shows the geometrical representations of the upper arm (101), the forearm (109), and the hand (105) in relation with the elbow joint (103) and the wrist (107) relative to the shoulder (100).

Each of the upper arm (101), the forearm (109), and the hand (105) has an orientation relative to a common reference system (e.g., the shoulder (100), a room, or a location on the Earth where the user is positioned). The orientation of the upper arm (101), the forearm (109), or the hand (105) can be indicated by a local coordinate system (151, 153, or 155) aligned with the upper arm (101), the forearm (109), or the hand (105).

The orientation of the upper arm (101) and the orientation of the hand (105), as represented by the local coordinate systems (151 and 155) can be calculated from the motion parameters measured by the IMUs in the module (113 and 105) attached to the upper arm (101) and the hand (105).

Since the forearm (109) does not have an attached IMU for the measurement of its orientation, the motion processor (145) uses a set of assumed relations between the movements of the forearm (109) and the hand (105) to calculate or estimate the orientation of the forearm (109) based on the orientation of the upper arm (101) and the orientation of the hand (105), as further discussed below.

FIG. 4 illustrates the determination of the orientation of a forearm according to one embodiment.

In FIG. 4, the coordinate system X₁Y₁Z₁ represents the orientation of the upper arm (101), where the direction Y₁ is along the lengthwise direction of the upper arm (101) pointing from the shoulder (100) to the elbow joint (103), as illustrated in FIG. 3. The directions X₁ and Z₁ are perpendicular to the direction Y₁. The direction Z₁ is parallel to the direction from the back side of the upper arm (101) to the front side of the upper arm (101); and the direction X₁ is parallel to the direction from the inner side of the upper arm (101) to the outer side of the upper arm (101).

When the arm is in a vertical direction pointing downwards with the hand (105) facing the body of the user, the lengthwise directions Y₁, Y₂, and Y₃ of the upper arm (101), the forearm (109), and the hand (105) are aligned with the vertical direction pointing downwards. When in such a position, the inner sides of the forearm (109) and the upper arm (101) are closest to the body of the user; and the outer sides of the forearm (109) and the upper arm (101) are away from the body of the user; the directions Z₁, Z₂, and Z₃ of the upper arm (101), the forearm (109), and the hand (105) are aligned with a direction pointing sideways to the user; and the directions Z₁, Z₂, and Z₃ of the upper arm (101), the forearm (109), and the hand (105) are aligned with a direction pointing to the front of the user.

Thus, the plane X₁Y₁ is parallel to the direction X₁ from the back side of the upper arm (101) to the front side of the upper arm (101), parallel to the lengthwise direction Y₁ of the upper arm (101), and perpendicular to the direction Z₁ from the direction from the inner side of the upper arm (101) to the outer side if the upper arm (101). The direction Z₁ coincides with an axis of the elbow joint about which the forearm (109) can rotate to form an angle with the upper arm (101) between their lengthwise directions. When the upper arm (101) is extended in the sideways of the user and in a horizontal position, the directions X₁ and Z₁ are aligned with (in parallel with) the front direction and vertical direction respectively.

The direction Y₂ is aligned with the lengthwise direction of the forearm (109) pointing from the elbow joint (103) to the wrist (107).

The direction Y₃ is aligned with the lengthwise direction of the hand (105) pointing from the wrist (107) towards the fingers.

When the upper arm (101) is extended in the sideways of the user and in a horizontal position, the directions Y₁, Y₂, and Y₃ coincide with the horizontal direction pointing the sideways of the user.

When the hand (105) is moved to an orientation illustrated in FIG. 4, the hand (105) can be considered to have moved from the orientation of the coordinate system X₁Y₁Z₁ through rotating (165) by an angle γ along the lengthwise direction Y₁ and then rotating (161) along the shortest arc (161) such that its lengthwise direction Y₃ arrives at the direction illustrated in FIG. 4. The rotation (161) along the shortest arc (161) corresponding to a rotation of the direction Y₁ by an angle β in a plane containing both the directions Y₁ and Y₃ along an axis perpendicular to both the directions Y₁ and Y₃ (i.e., the axis is perpendicular to the plane containing both the directions Y₁ and Y₃).

The projection of the direction Y₃ in the plane X₁Y₁ is assumed to be in the direction of the lengthwise direction Y₂ of the forearm (109). The projection represents a rotation (163) of the direction Y₁ by an angle γ in the plane X₁Y₁ along the direction Z₁ according to the shortest arc (163).

It is assumed that the rotation (165) of the hand (105) along its lengthwise direction is a result of the same rotation of the forearm (109) along its lengthwise direction while the forearm (109) is initially at the orientation aligned with the coordinate system X₁Y₁Z₁. Thus, when the hand (105) has an orientation illustrated in FIG. 4 relative to the orientation (X₁Y₁Z₁) of the upper arm (101), the orientation of the forearm (109) is assumed to have moved from the orientation of the coordinate system X₁Y₁ by rotating (165) along the lengthwise direction Y₁ and then rotating (163) in the plane X₁Y₁ along the direction Z₁.

Since the rotations (165, 161 and 163) can be calculated from the orientation of the hand (105) relative to the orientation of the upper arm (101) (e.g., using the orientation data measured by the IMUs of the arm module (113) and the handheld module (115)), the orientation of the forearm (109) can be calculated from the rotations (165 and 163) without measurement data from an IMU attached to the forearm (109).

After the orientations of the upper arm (101), the forearm (109) and the hand (105) are obtained, the motion processor (145) can compute the positions of the upper arm (101), the forearm (109) and the hand (105) in a three dimensional space (relative to the shoulder (100)), which allows the application (147) to present an arm of an avatar in a virtual reality, augmented reality, or mixed reality in accordance with the movement of the arm of the user. The positions of the upper arm (101), the forearm (109) and the hand (105) in a three dimensional space (relative to the shoulder (100)) can also be used to determine the gesture made by the user in the three dimensional space to control the application (147).

FIG. 5 shows a method to compute the orientation of a forearm according to one embodiment. For example, the method of FIG. 5 can be implemented in a system illustrated in FIG. 2 with an arm module (113) and a handheld module (115) attached to a hand (105) and an upper arm (101) in a way illustrated FIG. 1 and using the geometrical relations identified via FIG. 3 and FIG. 4.

In FIG. 5, a computing device (141) receives (201) motion data from an arm module (113) identifying an orientation of an upper arm (101) of a user, receives (203) motion data from a handheld module (115) identifying an orientation of a hand (105) of the user, and calculates (205) an orientation of a forearm (109) of the user connecting the hand (105) and the upper arm (101) without a sensor module on the forearm (109).

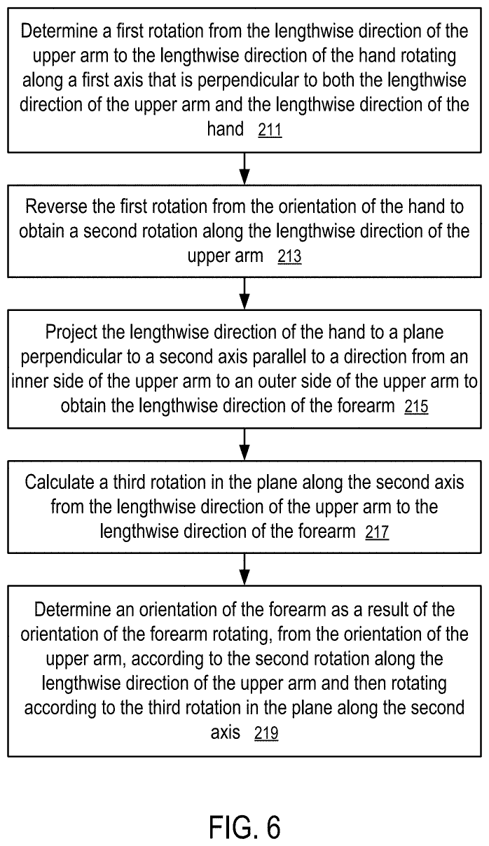

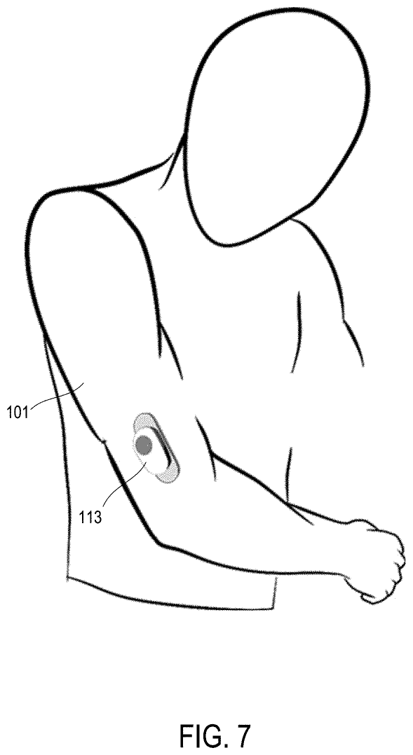

FIG. 6 shows a detailed method to compute the orientation of a forearm according to one embodiment. For example, the method of FIG. 6 can be used to implement the calculation (203) of the orientation of the forearm (109) in the method of FIG. 5.

In FIG. 6, the calculation (203) of the orientation of the forearm (109) is performed by: determining (211) a first rotation β from the lengthwise direction Y₁ of the upper arm (101) to the lengthwise direction Y₃ of the hand (105), where the first rotation β rotates along a first axis that is perpendicular to both the lengthwise direction Y₁ of the upper arm (101) and the lengthwise direction Y₃ of the hand (105); reversing (213) the first rotation β from the orientation of the hand (105) to obtain a second rotation γ along the lengthwise direction Y₁ of the upper arm (101); projecting (215) the lengthwise direction Y₃ of the hand (105) to a plane X₁Y₁ that is perpendicular to a second axis Z₁ parallel to a direction from an inner side of the upper arm (101) to an outer side of the upper arm (101) to obtain the lengthwise direction Y₂ of the forearm (109); calculating (217) a third rotation a that rotates within the plane X₁Y₁ and alone the second axis Z₁ from the lengthwise direction Y₁ of the upper arm (101) to the lengthwise direction Y₂ of the forearm (109); and determining (219) an orientation of the forearm (109) as a result of the orientation X₂Y₂Z₂ of the forearm (109) rotating, from the orientation X₁Y₁Z₁ of the upper arm (101), according to the second rotation γ along the lengthwise direction Y₁ of the upper arm (101), and then rotating according to the third rotation a in the plane X₁Y₁ and along the second axis Z₁.

As illustrated in FIG. 2, each of the arm module (113) and the handheld module (115) is a sensor module that has an inertial measurement unit (IMU) (131, 121) for their orientation measurements. Preferably, the sensor module has a wireless communication device or module (133, 123) for a wireless communication link (117, 119) with the computing device (141). Alternatively, wired connections can be used. The inertial measurement unit (IMU) (131, or 121) of the sensor module (113, or 115) may include a micro-electromechanical system (MEMS) gyroscope, a magnetometer, and/or a MEMS accelerometer.

The method of FIG. 6 allows the calculation of the estimated/approximated orientation of the forearm (109) without a need for a separate inertial measurement unit or sensor module attached to the forearm (109) of the user, which arrangement reduces the cost of the system and improves user experiences.

As an example, the orientation of the forearm can be calculated using the following quaternion calculations.

The orientations of the upper arm (101) and the hand (105) can be expressed as quaternion variables qₛ and qₕ. The quaternion of rotation between the upper arm (101) and the hand (105) can be calculated as qₕₛ=qₛ⁻¹*qₕ. The lengthwise direction of the upper arm (101) is known for the orientation transformation between the upper arm (101) and the hand (105) (e.g., vector {0; 1; 0} for the left hand and vector {0; −1; 0} for the right hand). When the lengthwise direction of the upper arm (101) is expressed as vector o, the lengthwise direction of the hand (105) can be calculated as vector h=qₕₛ*o*qₕₛ⁻¹. When the projection of h in the plane containing the lengthwise direction of the upper arm and the direction from the back of the upper arm to the front of the upper arm is expressed as vector f, the quaternion of rotation (α) along the shortest arc from the vector o to the vector f can be calculated as qzx_{fs}. Similarly, the quaternion of rotation (β) along the shortest arc from the vector o to the vector h can be calculated as qzxₕₛ. Since the quaternion of rotation (γ) along the lengthwise direction of the upper arm (101) is qzxₕₛ⁻¹*qₕₛ, the quaternion of rotation between the upper arm (101) and the forearm (109) is q_{fs}=qzx_{fs}*qzxₕₛ⁻¹*qₕₛ. Thus, the quaternion orientation of the forearm (109) is qᵣ=qₛ*q_{fs}.

In at least some embodiments, a sensor module (e.g., 115 or 113) is configured with a sticky surface for attaching the module to a user.

For example, an arm module (113) can have a sticky surface that can be used to attach the module (113) to the upper arm (101) of the user with or without another mechanism (e.g., an armband (111) or strap) to secure the arm module (113) to the upper arm (101).

FIG. 7 shows a sensor module (113) sticking to an upper arm (101) according to one embodiment. The sensor module (113) includes at least a micro-electromechanical system (MEMS) inertial measurement units (IMU) (131). The sensor module (113) can further include some or all of the components illustrated in FIG. 2, such as an LED indicator (137), a haptic actuator (138), a microcontroller (139), and/or a communication module (133). Optionally, the sensor module (113) can also include one or more buttons and/or other input devices similar to the buttons and input devices (125) in a handheld module (115).

In FIG. 7, the sticky surface of the sensor module (113) has sufficient stickiness to secure the sensor module (113) to the upper arm (101) without a band or strap. The sensor module (113) sticking to the upper arm (101) does not detach from the upper arm (101) and fall off during the arm movement to control operations of a computing device (141).

Optionally, the sticky surface is configured to be attached to a side of the upper arm (101) without wrapping around the upper arm (101).

For example, the sticky surface can be created by including silicone reusable material on a side of the sensor module (113) that is configured to be attached to the bare skin of the upper arm (101), or to the clothing wore over the upper arm (101).

The lack of a band or strap allows the sensor module (113) to be attached to other parts of the user, such as the torso of the user.

Alternatively, a band or strap (111) can be used in addition to the sticky surface to attach the sensor module (113) to the upper arm (101) of the user.

By using a sticky surface to attach the sensor module (113) to the user, errors in orientation measurements generated by the IMU (131) can be reduced.

For example, when the sensor module (113) is secured to the upper arm (101) with an armband (111) but without a sticky surface, the sensor module (113) can move around the arm (101) as the armband (111) twisting around the upper arm (101). Further, the armband (111) can slip up or down the upper arm (101) as a result of stretching and relaxing of the muscles in the upper arm (101). The re-positioning of the sensor module (113) relative to the upper arm (101) can introduce errors in tracking the orientation of the upper arm (101) and the calculation of the orientation of the lower arm (101).

The sticky surface of the sensor module (113) can reduce or eliminate the relative displacement between the sensor module (113) and the upper arm (101) and thus, reduce or eliminate the errors caused by the relative displacement.

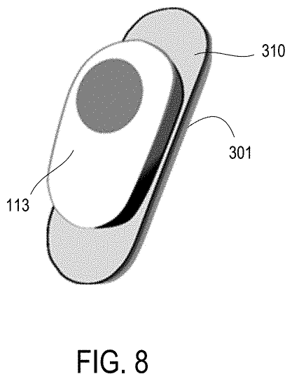

FIG. 8 shows a sensor module having a sticky pad for attaching to a user according to one embodiment.

In FIG. 8, the sensor module (113) has a housing in which the electronic components (e.g., 131, 133, 137, 138, and/or 139) are disposed. Further, the sensor module (113) includes a flexible, sticky, silicone pad (310). The housing of the sensor module (113) can be temporally attached to a sticky side of the pad (310), or permanently secured to the pad (310) (e.g., via glue, or fasteners). The back side (301) of the pad (310) facing away from the housing of the sensor module (113) is sticky and can be used to attach the sensor module (113) to the upper arm (101) of the user (or another part of the user).

The sticky pad (310) can be replaceable. For example, when the pad (310) loses its stickiness over time, the pad (310) can be removed from the housing of the sensor module (113); and another sticky pad can be attached to the sensor module (113) to replace the pad (310).

The sticky part of the sensor module (113) can be detachable from the sensor module (113) and/or the pad (310). For example, the sticky part and/or the stick pad (310) can be removably located/mounted on a platform, surface, or mounting structure of the sensor module (113) and/or the housing of the sensor module (113); and a user can optionally choose to use the sticky pad (310) for attaching the sensor module (113) to the upper arm (101) (e.g., in a way as illustrated in FIG. 7) or choose to use an elastic armband (111) for attaching the sensor module (113) to the upper arm (101) (e.g., in a way as illustrated in FIG. 1), or choose to use both the sticky pad (310) and the elastic armband (111) for attaching the sensor module (113) to the upper arm (101).

The present disclosure includes methods and apparatuses which perform these methods, including data processing systems which perform these methods, and computer readable media containing instructions which when executed on data processing systems cause the systems to perform these methods.

For example, the computing device (141), the arm module (113) and/or the handheld module (115) can be implemented using one or more data processing systems.

A typical data processing system may include includes an inter-connect (e.g., bus and system core logic), which interconnects a microprocessor(s) and memory. The microprocessor is typically coupled to cache memory.

The inter-connect interconnects the microprocessor(s) and the memory together and also interconnects them to input/output (I/O) device(s) via I/O controller(s). I/O devices may include a display device and/or peripheral devices, such as mice, keyboards, modems, network interfaces, printers, scanners, video cameras and other devices known in the art. In one embodiment, when the data processing system is a server system, some of the I/O devices, such as printers, scanners, mice, and/or keyboards, are optional.

The inter-connect can include one or more buses connected to one another through various bridges, controllers and/or adapters. In one embodiment the I/O controllers include a USB (Universal Serial Bus) adapter for controlling USB peripherals, and/or an IEEE-1394 bus adapter for controlling IEEE-1394 peripherals.

The memory may include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In the present disclosure, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to non-transitory, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system, comprising:
a computing device, comprising:
one or more processors; and
a plurality of sensor modules in electronic communication with the computing device via a communication module of at least one of the plurality of sensor modules, wherein the plurality of sensor modules each comprise:
a housing; and
an inertial measurement unit disposed in the housing;
wherein a first of the plurality of sensor modules comprises a sticky pad attached to the housing, wherein the sticky pad has a sticky surface configured to be sticking to a user to attach the first of the plurality of sensor modules to the user.

2. The system of claim 1, wherein each of the plurality of sensor modules comprises a communication module in electronic communication with the computing device.

3. The system of claim 1, wherein the communication module of the at least one of the plurality of sensor modules is in electronic communication with the plurality of sensor modules and the computing device.

4. The system of claim 1, wherein a second of the plurality of sensor modules comprises a plurality of input devices.

5. The system of claim 1, wherein the computing device comprises a memory storing a skeleton model representative of an arm of the user.

6. The system of claim 1, wherein the first of the plurality of sensor modules is configured to be secured to an upper arm of the user and the second of the plurality of sensor modules is configured to be held in a hand of the user, and wherein the computing device is configured to determine an orientation of a forearm of the user based on a first orientation of the first of the plurality of sensor modules and a second orientation of the second of the plurality of sensor modules.

7. The system of claim 6, wherein a first coordinate system is associated with the first of the plurality of sensor modules and a second coordinate system is associated with the second of the plurality of sensor modules.

8. The system of claim 1, wherein the communication module is configured to transmit orientation measurements generated by the inertial measurement unit of the at least one of the plurality of sensor modules to the computing device.

9. The system of claim 1, wherein the sticky pad is made of silicone.

10. The system of claim 1, wherein the inertial measurement unit includes a micro-electromechanical system (MEMS) gyroscope.

11. The system of claim 1, wherein at least one of the plurality of sensor modules comprises: an LED indicator, a haptic actuator, a microcontroller, a button, an input device, or any combination thereof.

12. The system of claim 1, wherein the sticky pad is removably attached to the housing.

13. The system of claim 1, wherein the sticky pad is replaceable.

14. The system of claim 1, wherein the housing of the first of the plurality of sensor modules is adapted to be attachable to an elastic armband; and at least one of the armband and the sticky pad is usable to secure the first of the plurality of sensor modules to an arm of the user.

15. The system of claim 1, wherein the one or more processors of the computing device are configured to:
receive motion data from the first of the plurality of sensor modules identifying an orientation of an upper arm of the user;
receive motion data from a second of the plurality of sensor modules identifying an orientation of a hand of the user; and
calculate an orientation of a forearm of the user connecting the hand and the upper arm, wherein the orientation is calculated without a sensor module being present on the forearm.

16. The system of claim 1, wherein the plurality of sensor modules comprises two sensor modules.
